(19) United States
(12) Patent Application Publication
(10) Pub. No.: US 2008/0195479 A1
(43) Pub. Date: Aug. 14, 2008

(54) Method And System For Providing Various Types Of Adverts

(75) Inventors: Kyoung-Ro Yoon, Seoul (KR); Hee-Kyung Lee, Daejon (KR); Jung-Won Kang, Seoul (KR); Jae-Gon Kim, Daejon (KR)

Correspondence Address: LADAS & PARRY LLP, 224 SOUTH MICHIGAN AVENUE, SUITE 1600, CHICAGO, IL, 60604, US

(73) Assignees: Electronics And Telecommunications Research Institute, Daejeon (KR); Konkuk University Industrial Cooperation Corp, Seoul (KR)

(21) Appl. No.: 11/722,555

(22) PCT Filed: May 16, 2005
(86) PCT No.: PCT/KR2005/001428

§ 371 Date: Jun. 22, 2007

(30) Foreign Application Priority Data
Dec. 24, 2004 (KR) 10-2004-0112396

(51) Int. Cl. G06Q 30/00

(52) U.S. Cl. 705/14

(57) ABSTRACT

Provided is a method for providing advertisements (ads) in diverse forms based on the type of an ad in a personalized broadcasting environment, and a system thereof, The method includes the steps of: a) analyzing metadata including a descriptor for defining relationship between an ad and a broadcasting program; b) determining the type of the ad among a normal ad type, a telescoped ad type, and a speedbump ad type based on relationship description used for the descriptor; and c) providing the ad based on the determined ad type. The technology of the present invention makes a user watch ads in diverse forms by adopting a “HowRelated” descriptor which defines the relationship between a broadcasting program and an ad and includes several types of relationship description to thereby inform a user of the location and the type of the ad.

### TECHNICAL FIELD

The present invention relates to a method and system for providing advertisements (ads or adverts); and, more particularly, to a method and system for providing advertisements in diverse forms according to the kind of advertisements in a personalized broadcasting environment.

### BACKGROUND ART

As broadcasting is digitalized, broadcasting environments are rapidly changed from conventional uni-directional broadcasting reception to multi-channel reception and even into such a complex form as accommodation of diverse reception terminals by connecting a broadcasting network with a communication network. An increasing number of broadcasting viewers want to get out of inactively receiving and watching broadcasting programs through limited channels and to participate in broadcasting services or demand to receive and watch desired programs at desired time.

The trend shows that the broadcasting environments are evolving into more complicated and personalized forms. Personalized broadcasting makes the viewers consume desired contents at desired time with diverse terminals based on their preferences in desired formats conveniently and efficiently in the diverse and new broadcasting environments.

The personalized broadcasting is to provide broadcasting contents suitably to a usage environment including user preference, terminal performance, network characteristics, and natural environment such as time, place and the feeling of a user.

The standards for the personalized broadcasting are divided into Phase 1, which is a TV Anytime 1 (TVA-1), and Phase 2, which is a TVA-2, based on an assumed system environment and a major function to be provided. The TVA-1 provides such application services as search, selection, acquisition and consumption of audio/video (AV) contents with a personal digital recoder (PDR) in an environment where a main broadcasting program is transmitted through a uni-directional broadcasting channel and additional metadata are available through a bi-directional network.

The TVA-2 extends the consumption environment of the TVA-1 which assumes a unit-directional broadcasting channel and a bi-directional network. It supports contents sharing between diverse terminals in a home network environment and provides a targeting service for providing contents that fits to diverse user environments. The TVA-2 also accommodates not only the AV of the TVA-1 but also diverse forms of contents.

Predetermined broadcasting advertisements (ads or adverts) such as TV commercials are reproduced repeatedly according to a contract with a broadcasting company while a predetermined program is broadcasted. The broadcasted ads are shown in other broadcasting channels, too, repeatedly. In an environment with sufficient storage capacity, it is possible to store a predetermined number of ads in a personal storage and reproduce the ads from the personal storage upon a signal transmitted through a broadcasting program. Of course, it is possible to reproduce the ads after receiving them from a communication network. When the environment is built up, it is possible to provide user-specified ads.

To provide the user-specified ads, the following information is in need. First, the location for an ad to be inserted into the broadcasting program should be specified. If necessary, the ad time, which means the length of the ad to be inserted into the specified location, may be specified.

When there is information defining ads available for a predetermined broadcasting program, the information needs to be linked with the broadcasting program.

The relationship between the broadcasting program and a predetermined ad can be defined by using a descriptor “HowRelated” of the TVA-1. The “HowRelated” descriptor may also define the relationship between a broadcasting program with another broadcasting program, the relationship between a broadcasting program with an ad, and the relationship between a broadcasting program with a related website.

FIG. 1 shows a classification scheme for linking ads according to a prior art. This is described in the TVA-1 S003v13 Part A.

If the relationship defined in the “HowRelated” is simply described as “Commercial Advert,” it is possible to check where the ad related to the broadcasting program is defined but it is not possible to know what kind of an ad it is and how the ad can be reproduced.

### DISCLOSURE

### Technical Problem

It is, therefore, an object of the present invention to provide a method for accessing to and providing advertisements (ads or adverts) to users in diverse forms according to the kind of an ad when the relationship between a broadcasting program and an ad is described in a personalized broadcasting environment, and a system thereof.

### Technical Solution

In accordance with one aspect of the present invention, there is provided a method for providing advertisements (ads or adverts), which includes the steps of: a) analyzing metadata including a descriptor for defining relationship between an ad and a broadcasting program; b) determining the type of the ad among a normal ad type, a telescoped ad type, and a speedbump ad type based on relationship description used for the descriptor; and c) providing the ad based on the determined ad type.

When the determined ad type is a telescoped ad type or a speedbump ad type, the presence of the telescoped ad or the speedbump ad may be notified to a user. When the user selects the telescoped ad in the middle of watching the broadcasting program, ad information related to a segment of the broadcasting program is provided to the user. When the user selects the telescoped ad in the middle of watching a normal ad, an ad with more detailed information than the normal ad is provided to the user. When the user selects the speedbump ad in the middle of watching the broadcasting program, brief ad information related to the segment of the broadcasting program is provided to the user. When the user selects the speedbump ad in the middle of watching a normal ad, an ad with more brief information than the normal ad is provided to the user. When the determined ad type is a normal ad, the normal ad is provided without notifying the user of the presence of the ad.

In accordance with another aspect of the present invention, there is provided a system for providing advertisements (ads or adverts), which includes: a metadata analyzing unit for analyzing metadata including a descriptor for defining relationship between an ad and a broadcasting program; an ad type determining unit for determining the type of the ad among a normal ad type, a telescoped ad type, and a speedbump ad type based on relationship description used for the descriptor; and an ad providing unit for providing the ad based on the determined ad type.

### Advantageous Effects

The technology of the present invention informs a user terminal of the location of type of an advertisement (ad or adverts) by adopting a descriptor “HowRelated” for defining the relationship between a broadcasting program and an ad so that the user can watch the ad in diverse forms.

### DESCRIPTION OF DRAWINGS

The above and other objects and features of the present invention will become apparent from the following description of the preferred embodiments given in conjunction with the accompanying drawings, in which:

FIG. 1 shows a classification scheme for linking an advertisement with a broadcasting program according to a prior art;

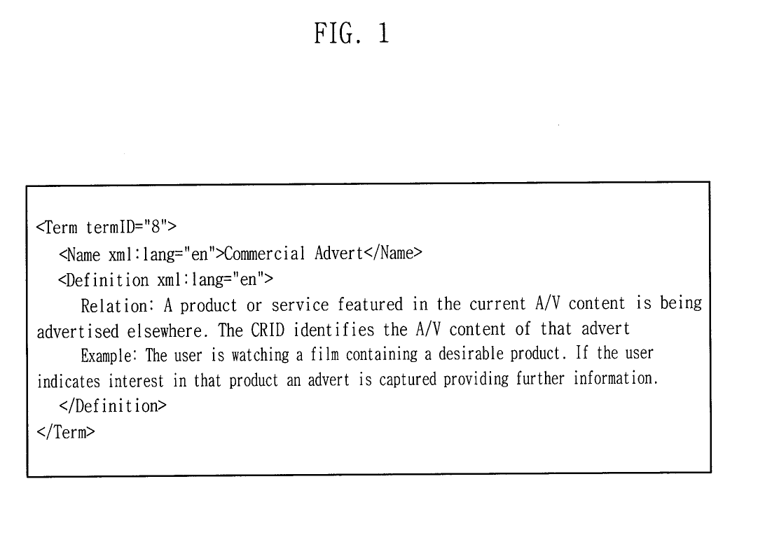

FIG. 2 describes a classification scheme related to an expanded ad in accordance with an embodiment of the present invention; and

FIG. 3 presents an exemplary description for reproducing an ad by using “HowRelated” in accordance with an embodiment of the present invention.

### BEST MODE FOR THE INVENTION

Other objects and aspects of the invention will become apparent from the following description of the embodiments with reference to the accompanying drawings, which is set forth hereinafter. Also, when it is considered that detailed descriptor on a prior art may blur the point of the present invention, the description will not be provided herein. Preferred embodiments of the present invention will be described in detail with the accompanying drawings hereinafter.

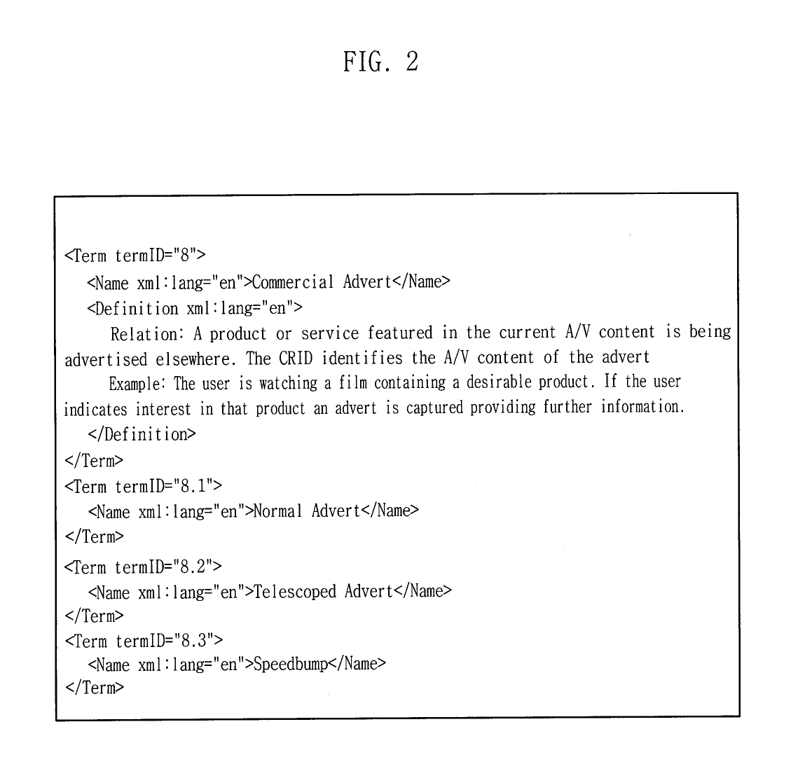

FIG. 2 describes a classification scheme related to an expanded ad in accordance with an embodiment of the present invention.

A descriptor “HowRelated” defines the relationship between an advertisement (ad or advert) and a broadcasting program and it includes three entries “Normal Advert,” “Telescoped Advert” and “Speedbump.”

First, when the relationship description is “Normal Advert,” it means that there is an ad related to the broadcasting program, i.e., an AV content, that is, it means that there is an interstitial content.

When an ad is inserted in the middle of a reproducing program, an ad linked in the relationship of “Normal Advert” can be inserted typically. In other words, the “Normal Advert” is used to link an ad to a predetermined segment of a broadcasting program.

The ad is reproduced when the reproduction of the program stops. After the reproduction of the ad finishes, the program resumes reproduction at the time point that the program stopped or at a time point a bit ahead of the time point that the program stopped.

When there is a “Normal Advert” ad, the broadcasting program stops and the ad begins to be reproduced without notifying the user of the presence of the ad.

If the relationship description used for the “HowRelated” is the “Telescoped Advert,” the related ad is linked with a segment of the broadcasting program and a user watches the related ad by selecting it in the middle of watching the segment. Also, it is possible to link a normal ad with another ad with detailed information and make the user get more detailed information by selecting the ad with detailed information in the middle of watching the normal ad.

The “Telescoped Advert” exists in a predetermined segment of a broadcasting program or an ad. When the user selects a “Telescoped Advert” ad, an ad related to the segment of the broadcasting program or a detailed-version of the ad is shown.

In short, the “Telescoped Advert” links a segment of a broadcasting program with a related ad and lets a user select and watch the related ad in the middle of watching the segment. Also, it is possible to link a normal ad with a detailed ad so that the user can select and watch the detailed ad in the middle of watching the normal ad.

When a predetermined segment includes the “Telescoped Advert” ad, the user terminal should notify the user of the presence of the “Telescoped Advert.”

When the relationship description used for the “HowRelated” descriptor is “Speedbump,” a normal ad is linked with a brief ad, and the user can select the brief ad in the middle of watching the normal ad. When the user selects a “Speedbump” ad, the brief ad of the normal ad is shown.

The “Speedbump” provides a brief ad with simpler information than the normal ad, when the user selects the speedbump ad in the middle of watching the broadcasting program or the normal ad.

Thus, when a segment includes a “Speedbump” ad, the user terminal should notify the user of the presence of the “Speedbump” ad.

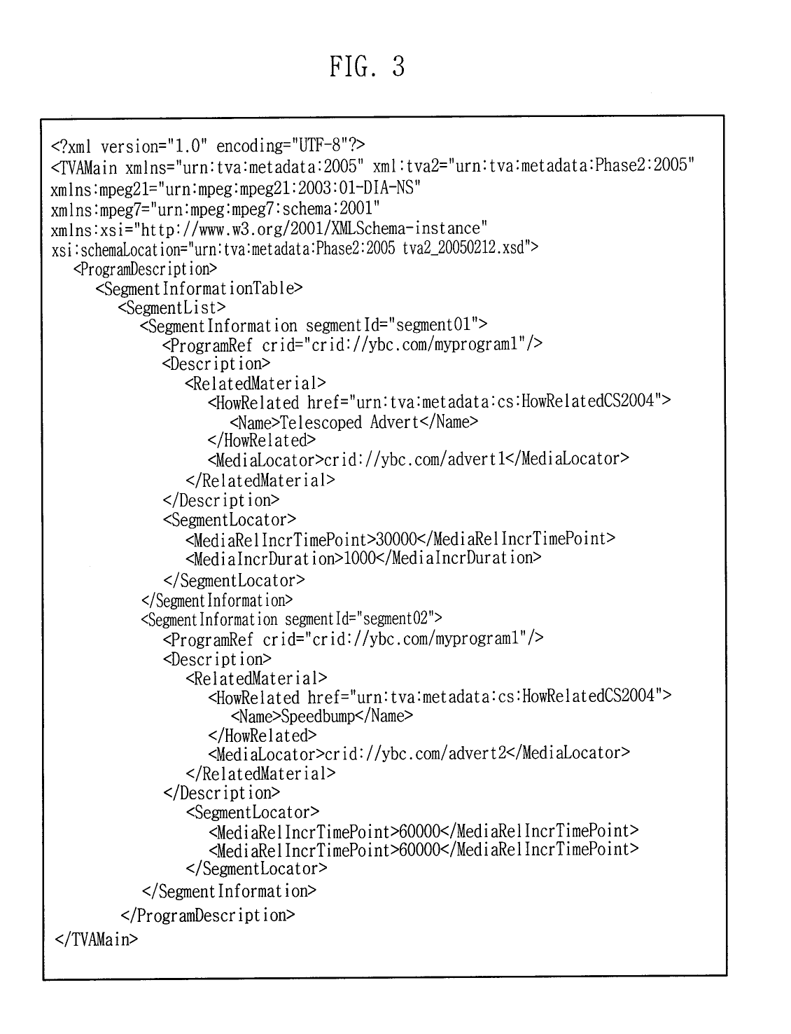

FIG. 3 presents an exemplary description for reproducing an ad by using the types of “HowRelated” descriptor in accordance with an embodiment of the present invention.

A “Telescoped Advert” type of an ad exists in 1,000 frames of a broadcasting program defined as crid://ybc.com/myprogram1 from the 30,000^{th} frame. The ad is defined as crid://ybc.com/advert1.

Also, a “Speedbump” type of an ad exists in 2,000 frames from the 60,000^{th} frame, and the ad is defined as crid://ybc.com/advert2.

Therefore, the user terminal reproduces the broadcasting program defined as crid://ybc.com/myprogram1 and then notifies the user of the presence of the “Telescoped Advert” ad in 1,000 frames from the 30,000^{th} frame. When the user selects the speedbump ad, the user terminal reproduces the crid://ybc.com/advert1 content and then goes to the 31,000^{th} frame to continue to reproduce the broadcasting program.

Also, the user terminal notifies the user of the presence of the “Speedbump” ad in 2,000 frames from the 60,000^{th} frame in the middle of reproduction of the same broadcasting program. When the user selects the speedbump ad, the user terminal reproduces the crid://ybc.com/advert2 content and then goes to the 62,000^{th} frame to continue to reproduce the broadcasting program.

The method of the present invention can be realized as a program and stored in a computer-readable recording medium.

While the present invention has been described with respect to certain preferred embodiments, it will be apparent to those skilled in the art that various changes and modifications may be made without departing from the scope of the invention as defined in the following claims.

### INDUSTRIAL APPLICABILITY

The technology of the present invention can be applied to personalized digital broadcasting of the TV Anytime (TVA).

1-14. (canceled)

15. A method for providing an advertisement, comprising the steps of:
generating a metadata including a descriptor for defining relationship between a broadcasting program and advertisement contents, wherein the advertisement contents have a classification scheme including a normal advertisement, a detailed advertisement, and a brief advertisement; and
transmitting the metadata to a user terminal.

16. The method as recited in claim 15, wherein the detailed advertisement has more detailed information than the normal advertisement and the brief advertisement has less information than the normal information.

17. The method as recited in claim 16, wherein the detailed advertisement or the brief advertisement is related to a segment of the broadcasting program.

18. An apparatus for providing an advertisement, comprising:
a generating unit for generating a metadata Including a descriptor for defining relationship between a broadcasting program and advertisement contents, wherein the advertisement contents have a classification scheme including a normal advertisement, a detailed advertisement, and a brief advertisement; and
a transmitting unit for transmitting the metadata to a user terminal.

19. The apparatus as recited in claim 18, wherein the detailed advertisement has more detailed information than the normal advertisement and the brief advertisement has less information than the normal information.

20. The apparatus as recited in claim 19, wherein the detailed advertisement or the brief advertisement is related to a segment of the broadcasting program.

21. A method for reproducing an advertisement, comprising the steps of:
receiving a metadata including a descriptor for defining relationship between a broadcasting program and advertisement contents, wherein the advertisement contents have a classification scheme including a normal advertisement, a detailed advertisement, and a brief advertisement;
determining one of the advertisements among the classification scheme in accordance with the descriptor; and
reproducing the determined advertisement.

22. The method as recited in claim 21, wherein the detailed advertisement has more detailed information than the normal advertisement and the brief advertisement has less information than the normal information.

23. The method as recited in claim 22, wherein when the determined advertisement is the detailed advertisement or the brief advertisement, a presence of the detailed advertisement or the brief advertisement is notified to a user.

24. The method as recited in claim 23, wherein the detailed advertisement or the brief advertisement is related to a segment of the broadcasting program.

25. An apparatus for reproducing an advertisement, comprising:
a receiving unit for receiving a metadata including a descriptor for defining relationship between a broadcasting program and advertisement contents, wherein the advertisement contents have a classification scheme including a normal advertisement, a detailed advertisement, and a brief advertisement;
a determining unit for determining one of the advertisements among the classification scheme using the descriptor; and
a reproducing unit for reproducing the determined advertisement.

26. The apparatus as recited in claim 25, wherein the detailed advertisement has more detailed information than the normal advertisement and the brief advertisement has less information than the normal information.

27. The apparatus as recited in claim 26, wherein when the determined advertisement is the detailed advertisement or the brief advertisement, a presence of the detailed advertisement or the brief advertisement is notified to a user.

28. The apparatus as recited in claim 26, wherein the detailed advertisement or the brief advertisement is related to a segment of the broadcasting program.
